(19) United States
(12) Patent Application Publication
(10) Pub. No.: US 2005/0123080 A1
(43) Pub. Date: Jun. 9, 2005

(54) Systems and methods for serial cancellation

(76) Inventors: Anand P. Narayan, Boulder, CO (US); Eric S. Olson, Milwaukee, WI (US)

Correspondence Address: TENSORCOMM, INC., 1490 W. 121ST AVE., SUITE 105, WESTMINISTER, CO, 80234, US

(21) Appl. No.: 11/003,881

(22) Filed: Dec. 3, 2004

Related U.S. Application Data
(63) Continuation-in-part of application No. 10/773,777, filed on Feb. 6, 2004.
(63) Continuation-in-part of application No. 10/699,954, filed on Nov. 4, 2003.
(63) Continuation-in-part of application No. 10/686,828, filed on Oct. 15, 2003.
(63) Continuation-in-part of application No. 10/686,829, filed on Oct. 15, 2003.
(63) Continuation-in-part of application No. 10/294,834, filed on Nov. 15, 2002.

(51) Int. Cl. H04B 1/38

(52) U.S. Cl. 375/346

(57) ABSTRACT

The systems and methods described and illustrated herein provide for serial interference suppression. In one embodiment, a Coded Signal Processing Engine (“CSPE”) serially cancels a plurality of channels corresponding to a plurality of signal paths interfering with a selected signal. For example, in a first interference cancellation, the CSPE may generate a first cancellation operator that is used to project a signal onto a subspace that is substantially orthogonal to a subspace of an interfering signal path and channels of that path. The CSPE may subsequently perform another signal cancellation on the interference canceled output signal of the first signal cancellation by generating a second cancellation operator that projects the signal onto a subspace that is substantially orthogonal to a subspace of another interfering signal path and associated channels. The interference canceled output signal of the second cancellation, therefore, has at least two signals substantially canceled.

### CROSS-REFERENCE TO RELATED APPLICATIONS

This application is a continuation-in-part of commonly owned and co pending U.S. patent application Ser. No. 10/773,777 (filed Feb. 6, 2004; the “'777 application”), Ser. No. 10/699,954 (filed Sep. 23, 2003; the “'954 application”), Ser. No. 10/686,828 (filed Oct. 15, 2003; the “'828 application”), Ser. No. 10/686,829 (filed Oct. 15, 2003; the “'829 application”), Ser. No. 10/699,360 (filed Oct. 31, 2003; the “'360 application”), Ser. No. 10/294,834 (filed Nov. 15, 2002; the “'834 application”), Ser. No. 10/686,359 (filed Oct. 15, 2003; the “'359 application”) Ser. No. 10/763,346 (filed Jan. 23, 2004; the “'346 application”), TCOM19 (filed Sep. 7, 2004; the “'TCOM19 application”) and TCOM20 (filed Sep. 7, 2004; the “'TCOM20 application”), which are all hereby incorporated by reference. This application is also related to Ser. No. 09/988,219 (filed Nov. 19, 2001; the “'219 application”), which is hereby incorporated by reference.

### BACKGROUND

1. Field of the invention

The invention generally relates to the field of communications. More specifically the invention is related to interference suppression for use in coded signal communications, such as Code Division Multiple Access (“CDMA”) (e.g., such as cdmaOne and cdma2000), Wideband CDMA (“WCDMA”), Broadband CDMA, Universal Mobile Telecommunications System (“UMTS”) and/or Global Positioning System (“GPS”).

2. Discussion of the Related Art

In CDMA communication, coded signals are used to communicate between devices. Some typical CDMA telephony systems use combinations of “spreading codes” and “covering codes” to encode signals. These encoded digital signals are used to convey voice, data and/or other forms of digital communication. As used herein spreading codes are pseudorandom number, or pseudo-noise, (“PN”) sequence codes and are known to those skilled in the art. Covering codes are also known those skilled in the art.

A spreading code encodes a data signal by applying a noise-like code sequence to the data at a rate faster than that of the data. Namely, the spreading code is applied to the data such that there are multiple “chips” of the code for any given element of data. Such an application of the spreading code is commonly referred to as direct sequence spreading of the data. A short code is an example of a spreading code. Chips and their associated chip rates are known to those skilled in the art.

A covering code may further encode the signal to provide “channelization” of a signal. For example, each unique covering code as it is applied to a spread signal provides a unique communication channel for the spread signal. This channelization allows a signal to be divided into a number of individual communication channels that may be either shared or assigned to specific users. Covering codes typically include families of codes that are either orthogonal (e.g., Walsh codes) or substantially orthogonal (e.g. Quasi Orthogonal Function codes; i.e., “QOF” codes). Such covering codes are known to those skilled in the art.

Interference degrades signal recovery and processing capabilities of a receiver by hindering the reception of a selected signal. While the above-mentioned codes can be used to differentiate signals, interference from unwanted signals is a persistent problem in CDMA telephony communications. For example, interference can be the result of receiving one or more unwanted signals simultaneously with a selected signal. These unwanted signals can be coded signals having properties that are similar to that of the selected signal. Because of code similarities and corresponding signal energy, the coded signals often have a tendency to interfere with one another and disrupt the recovery of the selected signal. The lack of orthogonality of the transmitted signals results in “leakage” from one signal into another. Examples of such interference include “cross-channel” interference and “co-channel” interference.

Co-channel interference may include multipath interference from the same transmitter; wherein a transmitted signal takes unique paths that results in one path (e.g., an interfering signal path) and another path (e.g., a selected signal path) to differentially arrive at a receiver, thereby degrading recovery of the selected signal. Cross-channel interference may include interference caused by signal paths of other transmitters degrading recovery of the selected signal path. Such interference can corrupt data as long as it is present in any substantial form. A signal path as used herein generally refers to one or more channels of a signal associated with a particular PN code sequence and/or phase that follow a particular physical path. Such a signal path may have an associated timing alignment in the spreading code, such as that associated with multipath and/or predetermined offsets of unique CDMA base stations.

“Rake” receivers operate in multipath environments that include such interference to improve reception of the selected signal via the combination of signal paths. Rake receivers have a plurality of “fingers,” wherein each finger of the rake receiver independently estimates channel gain and other signal characteristics, such as phase, of the selected signal path to more accurately demodulate and subsequently retrieve underlying data of the selected signal by combining multiple copies of the signal. Although rake receivers can improve data retrieval of a received signal, present rake receivers do not reduce cross-channel interference and/or co-channel interference.

### SUMMARY

The systems and methods described and illustrated herein provide for serial interference suppression. As used herein, serial interference suppression generally refers to the sequential substantial cancellation of interfering channels from a signal path. In one embodiment of the invention, a Coded Signal Processing Engine (“CSPE”) serially cancels a plurality of channels corresponding to a plurality of signal paths interfering with a selected signal. The CSPE includes a plurality of matrix generators that are used to generate interference matrices with each matrix comprising elements of one or more interfering channels of one signal path selected for cancellation. The CSPE also includes one or more processors configured for using the matrices to generate cancellation operators. Examples of such interfering signals include co-channel interference and cross-channel interference typical in CDMA telephony.

The CSPE applies the cancellation operators to signals that are input to the CSPE to cancel one or more interfering signals from the input signals. One or more of these signal inputs are feedback signals for the CSPE to perform successive cancellation thereon. To illustrate, a received signal y may be input to the CSPE to perform a signal cancellation thereon. The CSPE performs this initial signal cancellation by generating a cancellation operator used to cancel one or more channels from a chosen signal path. This interference canceled output signal may then be transferred to a processing finger of a rake receiver coupled thereto for processing. The interference canceled output signal, however, may also be fed back to an input of the CSPE such that the CSPE may perform successive cancellation thereon to substantially remove another one or more channels from another chosen signal path. As used herein, an interference canceled output signal is a signal having channels of one or more selected interfering signal paths substantially removed therefrom. The term “interference canceled output signal” is commonly referred to herein as an “output canceled signal.”

In one embodiment of the invention, the cancellation operators used in canceling the interfering signals are projection operators, as described in the '828, TCOM0020 and the '346 applications. For example, in the first interference cancellation, the CSPE generates a first projection operator that is used to project a signal onto a subspace that is substantially orthogonal to a subspace spanned by an interfering signal path and the channels of that path. The CSPE may subsequently perform another signal cancellation on the output canceled signal of the first signal cancellation by generating a second projection operator that projects the output canceled signal onto a subspace that is substantially orthogonal to a subspace spanned by another interfering signal path and its channels. The output canceled signal of the second projection therefore substantially includes the desired signal projected onto a subspace that is substantially orthogonal to the subspaces spanned by the signals of the two interfering signal paths. One example of successive signal cancellations via signal projections is as follows:
(Cancellation Operation 1) y₁=Pₛ₁^{⊥}y;
(Cancellation Operation 2) y₂=Pₛ₂^{⊥}y₁; and continuing through
(Cancellation Operation N) y_{N}=Ps_{N}^{⊥}y_{N-1},
   wherein N is an integer greater than one, Pₛ₁^{⊥}, . . . , P_{sN}^{⊥} are the projection operators—each configured for canceling a selected one or more interfering signals, y is a received signal, and y_{1, . . . , N-1} are the successively canceled output signals.

The projection operator may be generated based on a signal received at a particular input to the CSPE. For example, the projection operator may be generated based on vectors derived from either the baseband digital received signal y or the interference canceled output signal (e.g., y₁). The serial cancellations described herein may improve signal to noise ratio (“SNR”) for a signal of interest (“SOI”) by successively and substantially canceling, or removing, interfering signals. The number of serial interference cancellations is a matter of design choice, taking into account factors, such as the number of available processing fingers, processor speed and/or acceptable time delays associated with successive cancellations. For example, the number of successive cancellations performed on an interference canceled output signal may be based on the processing constraints within a receiver.

The CSPE may also perform signal cancellations upon reference codes x. For example, the CSPE may perform a signal cancellation upon a reference code x to generate an interference canceled output reference code x′. This interference canceled output reference code x′ can thereby be input to the CSPE for a successive interference cancellation. This successive cancellation generates an interference canceled output reference code x″. These coded reference signals may comprise “on-time” PN codes of signals, covering codes and/or phase estimates that are used for the demodulation of selected signals. On-time as used herein refers to a particular timing alignment for a PN code. Such a timing alignment may correspond to code tracking of a selected signal path by a receiver.

In one embodiment, each vector, or submatrix, of an interference matrix may represent a particular path of an interfering signal and can include elements associated with the PN code of the path. Each submatrix of a matrix may represent selected channels of a particular interfering path using a covering code of the channel. In a second embodiment, the matrix may be constructed with one or more composite interference vectors, such as those described in the '360 and the TCOM0020 applications. Moreover, the elements of a particular path can have phase, sign information and/or amplitude information associated with the interfering channels for that path imparted on the vector elements.

Additional embodiments of the invention and corresponding objectives and advantages of particular embodiments will be apparent in view of the detailed description that follows.

### BRIEF DESCRIPTION OF THE DRAWINGS

FIG. 1 is a block diagram of a CSPE in one exemplary embodiment of the invention.

FIG. 2 is another block diagram of the CSPE in one exemplary embodiment of the invention.

FIG. 3 is a block diagram of the CSPE configured with a receiver in one exemplary embodiment of the invention.

FIG. 4 is a block diagram of the CSPE and the receiver illustrating receiver circuitry in one exemplary embodiment of the invention.

FIG. 5 is a block diagram of the CSPE and the receiver illustrating another receiver circuitry in one exemplary embodiment of the invention.

FIG. 6 is a block diagram of the CSPE and the receiver illustrating another receiver circuitry in one exemplary embodiment of the invention.

FIG. 7 is a block diagram of the CSPE and the receiver illustrating another receiver circuitry in one exemplary embodiment of the invention.

FIG. 8 is a flow chart illustrating one exemplary methodical embodiment of the invention.

### DETAILED DESCRIPTION OF THE DRAWINGS

While the invention is susceptible to various modifications and alternative forms, specific embodiments thereof have been shown by way of example in the drawings and are herein described in detail. It should be understood, however, that it is not intended to limit the invention to the particular form disclosed. Rather, the invention is to cover all modifications, equivalents, and alternatives falling within the spirit and scope of the invention as defined by the claims.

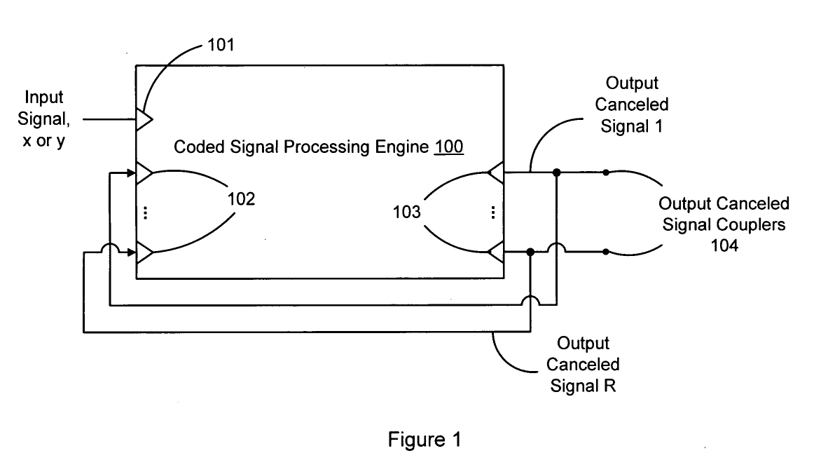

FIG. 1 is a block diagram of CSPE 100 in one exemplary embodiment of the invention. In this embodiment, CSPE 100 may provide signal cancellation to a plurality of input signals, such as received digital baseband signals y, output canceled signals (i.e., data signals with one or more interfering signals substantially removed), on-time PN reference codes x, output canceled on-time PN reference codes (i.e., on-time PN reference codes with one or more interfering signals substantially removed). CSPE 100 may perform successive signal cancellations by feeding back signals, which already have one or more interfering signals substantially removed therefrom.

CSPE 100 is illustrated as comprising a first input 101 configured for receiving an input signal. For example, CSPE 100 may be configured for receiving a received digital baseband signal or a selected on-time PN reference code via input 101 for performing a signal cancellation thereon. Additionally, CSPE 100 may be configured with a plurality of second inputs 102. Each of these inputs is configured for receiving an output canceled signal (i.e., labeled Output Canceled Signal_{1 . . . R}) via outputs 103. Ports 101 and 102 maybe any of a well known couplings used to receive a digital signal.

The output canceled signals are generated by CSPE 100 when a signal cancellation is performed upon an input signal. For example, a signal provided to input 101 has cancellation performed on it in which a first set of one or more channels corresponding to a first signal path is substantially removed. This signal cancellation produces an output canceled signal₁ which may be fed back to one of the second CSPE 100 inputs 102 via one of the outputs 103 for successive cancellation. The signal from output 103 may be fed back to CSPE inputs 102 R-1 times to provide for successive interference cancellation. Thus, an output canceled signal_{R} may have an R^{th} set of one or more channels corresponding to an R^{th} signal path substantially removed. As each output canceled signal may be fed back to an input 102 of CSPE 100 in this serial embodiment, a plurality of output canceled signals may be generated with each signal having more interfering signals canceled therefrom than that of a signal used as the input to the signal cancellation.

These Output Canceled Signals_{1 . . . R} may also be transferred to output canceled signal couplers 104 to transfer the signals to a device coupled thereto. For example, each of these output canceled signals may be transferred to a rake receiver having a plurality of processing fingers. Each processing finger of the rake receiver is capable of receiving, tracking and demodulating an output canceled signal.

While one exemplary preferred embodiment has been shown and described, the invention is not intended to be limited to the preferred embodiment. Rather, the invention is only intended to be limited by the language recited in the claims and their equivalents.

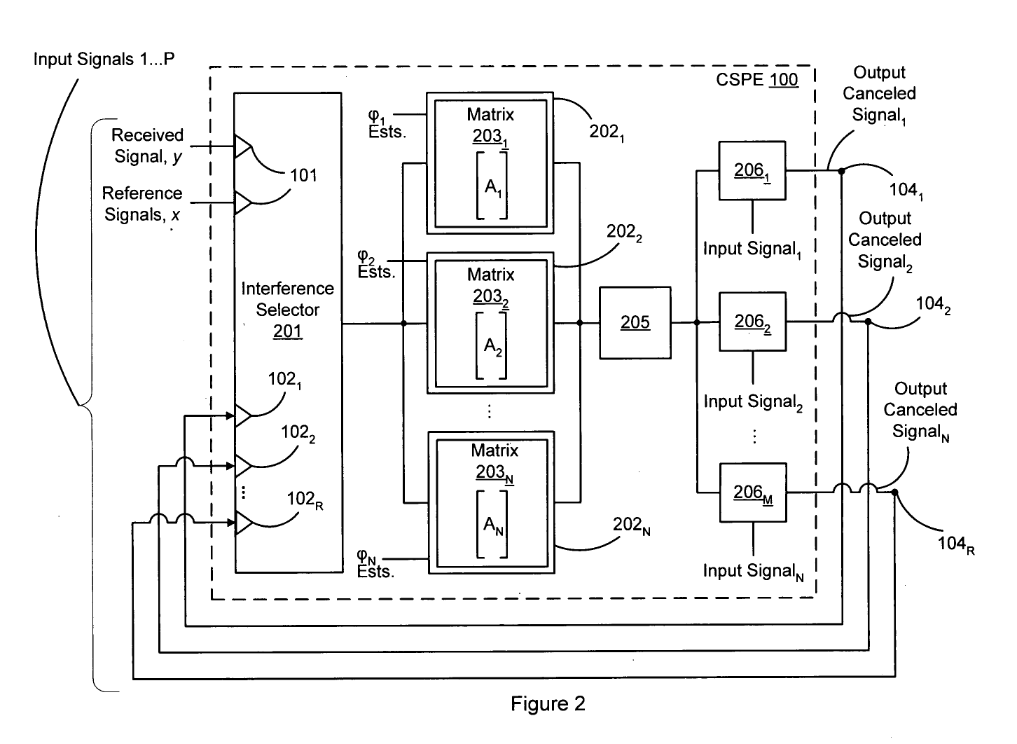

FIG. 2 is another block diagram of CSPE 100 in one exemplary embodiment of the invention. CSPE 100 is used to substantially cancel interfering channels of selected signal paths from a signal received through inputs 101 to generate substantially interference canceled signals, or output canceled signals (i.e., labeled Output Canceled Signals_{1 . . . R}). CSPE 100 substantially cancels selected interfering signals by applying a cancellation operator to an input signal, such as a received signal y or selected coded reference signals x received through inputs 101. In this embodiment, CSPE 100 is additionally configured for receiving feedback output canceled signals via inputs 102 (i.e., labeled 102_{1 . . . R}) from which cancellation operators are generated and applied thereto to substantially cancel selected interfering signals from the feedback signals.

CSPE 100 includes interference selector 201 for selecting interfering signal paths and/or corresponding interfering channels. Interference selector 201 may then provide on-time interfering PN codes of those selected paths and/or selected channel covering codes to matrix generators 202 (labeled 202_{1 . . . M}) of CSPE 100. The interference selector may select the interfering signal paths and channels based on pre-determined criteria, such as amplitude and/or timing alignment. Matrix generators 202 may be configured for using the PN codes, Walsh codes and/or phase estimates (labeled φ_{1 . . . N} Ests.) of the selected interfering signal paths to generate matrices 203 (labeled matrices 203_{1 . . . N}).

Each matrix 203 comprises a submatrix A (labeled submatrices A_{1 . . . N}, wherein N is an integer greater than one). Further, the submatrices A comprise elements representing components of the interfering codes (e.g., such as those elements described in the '346 and the '360 applications). For example, each vector of the submatrix may include elements representing a unique code of an interfering signal path and one or more associated channels.

Alternatively, a single vector may comprise a composite of two or more vectors with each vector representing one interfering channel of the same signal path. The composite vector can be formed from a linear combination of two or more vectors with scaling proportional to the amplitude of each signal. For example, the composite vector may be constructed as shown and described in the '829 and the 'TCOM20 applications. The codes are typically on-time PN codes of selected interfering signal paths and corresponding Walsh codes of the selected interfering channels. Each interference vector may be multiplied by a phase estimate of the corresponding selected interfering signal path. Phase estimation is exemplified in the '346 application.

As submatrices A may be used to represent multiple interfering signals corresponding to a signal path, each matrix 203 may be representative of a unique interfering signal path and its associated interfering channels. For example, A₁ may comprise one or more of selected channels of a first interfering signal path. Matrix 203₁ may include a single vector corresponding to one interfering channel of A₁. A₂ may comprise one or more of selected channels of a second interfering signal path. Matrix 203₂ may include a single vector corresponding to an interfering channel of A₂. The submatrix A_{N} of matrix 203_{N} (i.e., A_{N}) may comprise one or more selected channels of an interfering signal path. Matrix 203_{N} may therefore include vectors corresponding to the interfering channels of A_{N}.

A signal path or individual channels of a signal path can be canceled with one or more vectors, wherein each vector comprises elements of an interfering channel or composite elements of multiple channels. Each matrix comprising these vectors is used to generate cancellation operators, which substantially cancels the channels of a signal path that forms the matrix. A generated matrix 203₁ may, therefore, be used to generate a cancellation operator that substantially cancels A₁, wherein A₁ is a plurality of selected channels from the first interfering signal path. Similarly, matrix 203₂ may be used to generate a cancellation operator that substantially cancels A₂, wherein A₂ is a plurality of selected channels from the second interfering signal path. As a further illustration, matrix 203_{N} may be used to substantially cancel a submatrix A_{N}, wherein A_{N} is a plurality of selected channels from an N^{th} signal path.

Alternatively, a vector of a matrix 203 may comprise elements of more than one selected channel of a selected interfering signal path. For example, a vector of matrix 203₁ may comprise elements of more than one selected channels of A₁. As such, a composite interference vector may allow for the cancellation of a plurality of channels of A₁. Similarly, a vector of matrix 203₂ may comprise elements of more than one selected channels of A₂. As such, a composite interference vector may similarly allow for the cancellation of the a plurality of channels of A₂. As a further illustration, a plurality of composite interference vectors may be generated for A_{N}. The matrix 203_{N} may therefore comprise a plurality of composite interference vectors corresponding to channels of A_{N}. Composite interference vectors are described and illustrated in further detail in the '834 and the TCOM0020 patent applications. Those skilled in the art should readily recognize that matrices 203 may comprise various combinations of submatrices and/or composite interference vectors.

CSPE 100 uses each matrix 203 to generate cancellation operators for selective cancellation of interfering signals. Accordingly, CSPE 100 includes processor 205 configured for processing matrices 203 to generate the cancellation operators. The cancellation operators may be projection operators that are used to project selected coded signals substantially orthogonal to the subspace spanned by the interfering signals (e.g., the submatrix A representing a plurality of channels corresponding to an interfering signal path) so as to substantially cancel or remove the signals from the selected coded signals. For example, processor 105 can use matrices 203 to generate projection operators according to the following form:
Pₛ^{⊥}=I−S(S^{T}S)⁻¹S^{T}, (Eq. 1)
where Pₛ^{⊥} is a projection operator, I is an identity matrix, S is an interference matrix 203 and S^{T} is a transpose of the matrix 203. In this embodiment, the projection operator is applied to the received signal according to the following form:
y′=y−S(S^{T}S)⁻¹S^{T} y, (Eq. 2)
where y′ is the output canceled signal. Such projection operators and their associated constructions are described in the '346, the '360, the '829, the '219 and the '834 applications.

The interference matrix S comprises interference vectors s that are typically not orthogonal. In one embodiment, an approximation of the projection can be generated by assuming that the interference vectors s form an orthogonal set. The projection operator is applied to the received signal according to the following form:

$${y}^{′} \approx y - {\sum }_{j = 1}^{t} \frac{〈 {s}_{j} , y 〉}{{‖ {s}_{j} ‖}^{2}} {s}_{j} \qquad ( Eq . 3 )$$

where y′ is again the output canceled signal, sⱼ is the j^{th} column vector of S and t is the number of vectors in S.

CSPE 100 applies the cancellation operators to selected input signals (labeled “Input Signal_{1 . . . P}” where P is a positive integer) via a plurality of corresponding applicators 206_{1 . . . N} to substantially cancel the interfering signals. Each applicator 206 applies one of the cancellation operators to an input signal. CSPE 100 is configured for performing interference cancellation in a serial manner, wherein each application of a cancellation operator typically provides a unique output canceled signal (labeled “Output Canceled Signal_{1 . . . R}) which may be subsequently fed back to the CSPE for another cancellation.

As an example of cancellation using the same signal notations of “A” described above, applicator 206₁ may apply a projection operator P_{A1}^{⊥} to an input signal. The projection operator P_{A1}^{⊥}, in this example, is generated from a matrix 203₁ comprising elements of A₁ and the input signal is the received signal y. Once applied to the received signal y, applicator 206₁ produces an Output Canceled Signal₁ that substantially corresponds to y_{A1}′=P_{A1}^{⊥}y, where y_{A1}′ is the received signal with A₁ substantially removed.

The Output Canceled Signal₁ may be transferred to a receiver for processing of the output canceled signal via CSPE output canceled signal coupler 104₁. Additionally, Output Canceled Signal₁ may be fed back from output canceled signal coupler 104₁ to interference selector input 102₁ such that another interfering signal may be selected for cancellation from Output Canceled Signal₁. Accordingly, a second projection operator P_{A2}^{⊥} is generated from and applied to the Output Canceled Signal₁ to generate Output Canceled Signal₂ corresponding to y_{A1A2}′=P_{A2}^{⊥y}_{A1}′, where y_{A1A2}′ is Output Canceled Signal₁ with A₂ substantially removed (A₁ was substantially removed in the previous cancellation).

In one embodiment of the invention, Output Canceled Signal₂ may be similarly transferred to a receiver for processing of the output canceled signal via output canceled signal coupler 104₂. As well, Output Canceled Signal₂ may be fed back from output canceled signal coupler 104₂ to interference selector input 102₂ such that one or more interfering signals may be selected for cancellation from Output Canceled Signal₂. For example, a third projection operator P_{AN}^{⊥} may be generated from and applied to the Output Canceled Signal₂ to generate Output Canceled Signal_{N} corresponding to y_{AN}′=P_{AN}^{⊥}y_{A1A2}′, where y_{AN}′ is Output Canceled Signal₂ with A_{N} substantially removed. This Output Canceled Signal_{N} may also be transferred from output canceled signal coupler 104_{R} to a receiver for processing and/or interference selector input 102_{R} for another cancellation.

These successive cancellations performed on output canceled signals serially cancel one or more channels from a signal path from an input signal. Accordingly, serial as used herein implies signal path and channel cancellations of output canceled signals that are successively fed back to a CSPE. The invention, however, is not intended to be limited to the exemplary successive cancellation described herein. Those skilled in the art should readily recognize that other types of successive cancellations may be performed. For example, a cancellation operator of P_{A4}^{⊥} may be applied to a received signal y to generate an Output Canceled Signal₁. That Output Canceled Signal₁ may have a cancellation operator of P_{A2}¹⁹⁵ applied thereto to produce an Output Canceled Signal₂.

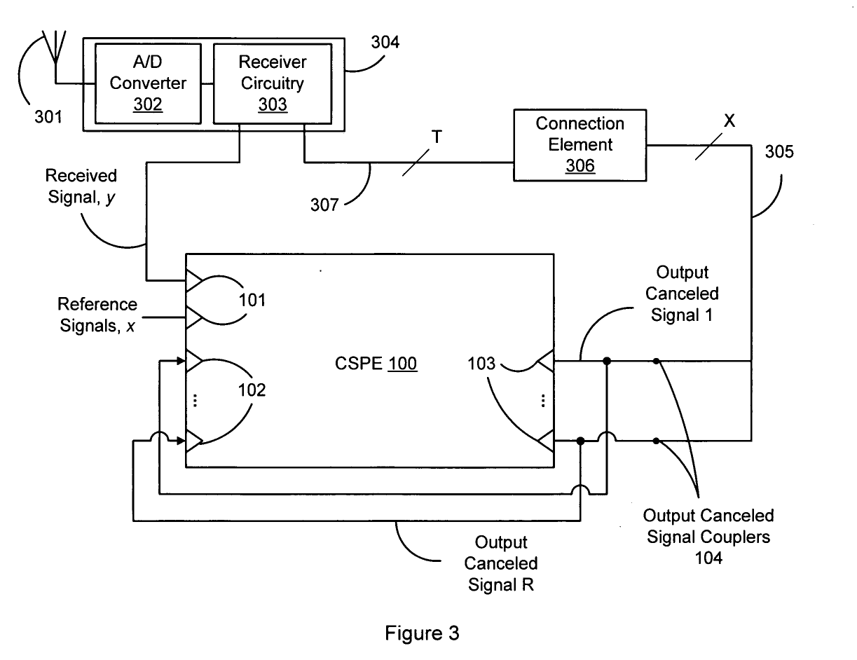

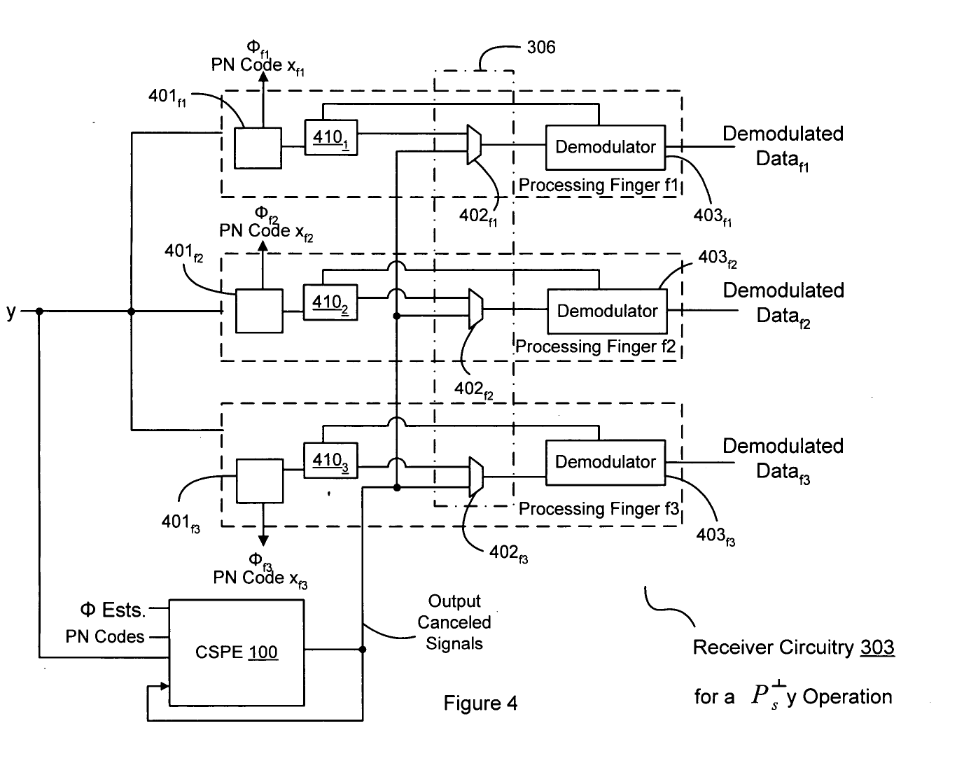

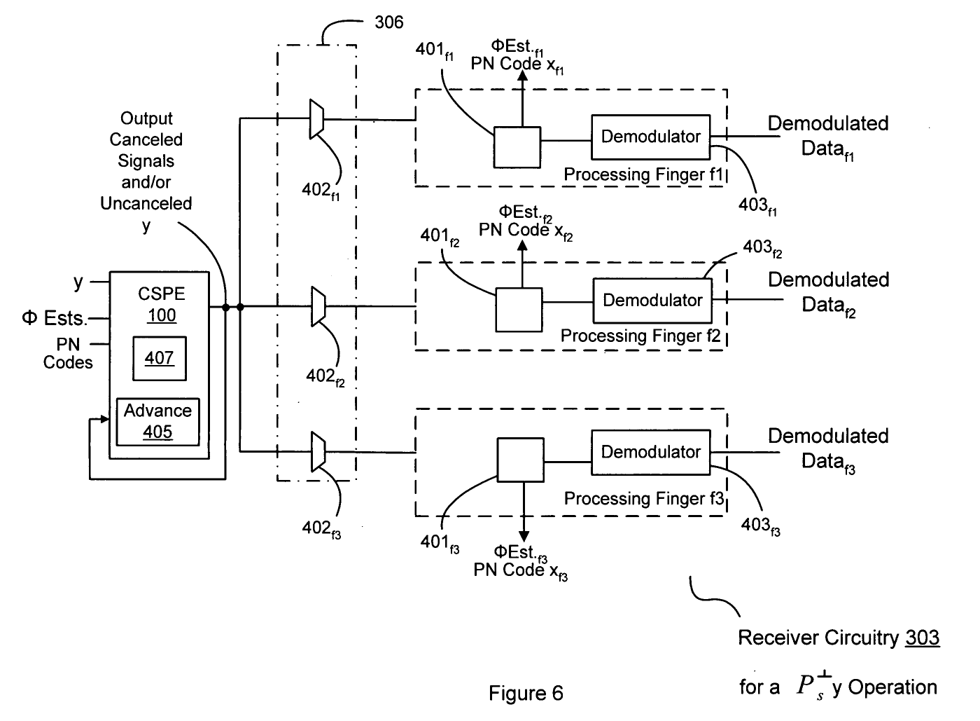

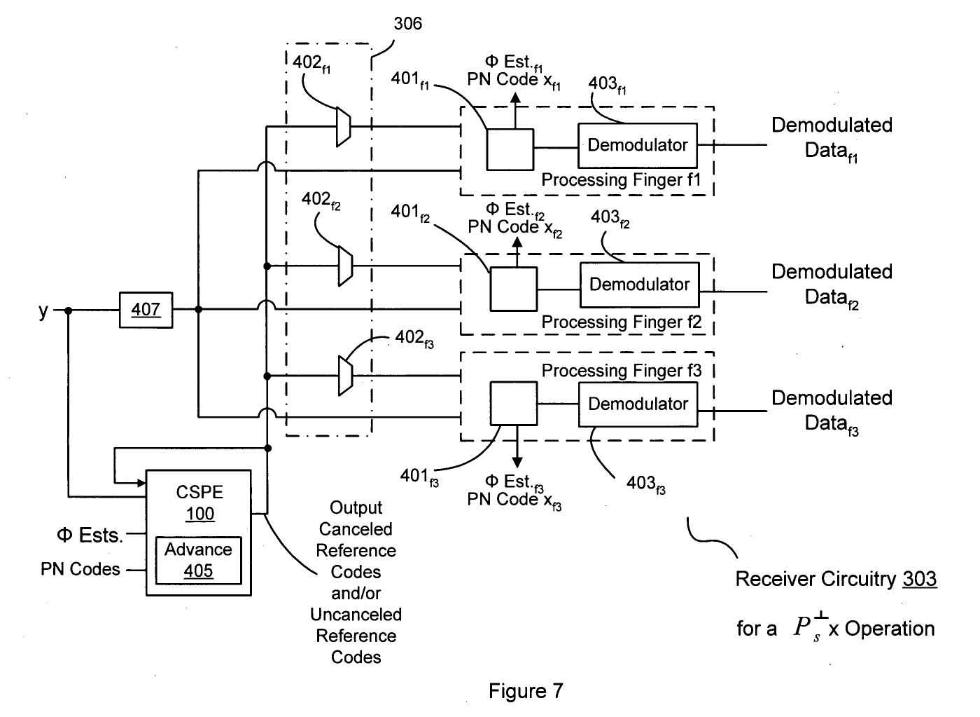

Additionally, the exemplary embodiment should not be limited to the type of signal (e.g., a input signal) for which cancellation is performed thereon. For example, in one embodiment, the projection operators are serially applied to coded reference signals x to produce Output Canceled Signals_{1 . . . R}. This application substantially removes components of the selected interferers that lie in the direction of the selected reference signal. Exemplary embodiments wherein the input signal is a received signal y or a coded reference signals x are shown and described in further detail in FIGS. 3, 4, respectively, and in FIGS. 6 and 7, respectively.

Moreover, the invention is not intended to be limited to the number of applicators 206, input signals, output canceled signals, matrix generators 202 and processors 205 shown and described herein. For example, processor 205 may be either a single processor configured for generating a plurality of cancellation operators or it may represent a plurality of processors, each of which is similarly configured for generating a cancellation operator. Examples of such processors include, but are not limited to, general purpose processors, Application Specific Integrated Circuits (“ASIC”), Digital Signal Processors (“DSP”) and Field Programmable Gate Arrays (“FPGA”). In one embodiment, the processor may be operably controlled via software, hardware and/or firmware instructions to generate the cancellation operators. Those skilled in the art are familiar with processors, ASICs, DSPs and FPGAs, software, hardware, firmware and the various combinations thereof, which may be used implement the embodiments described herein. For at least the reasons, the invention should only be limited to the claims and their equivalents.

Computer programs (i.e., software and/or firmware) implementing the method of this invention will commonly be distributed to users on a distribution medium such as a SIM card, a USB memory interface, or other computer-readable memory adapted for interfacing with a consumer wireless terminal. Similarly, computer programs may be distributed to users via wired or wireless network interfaces. From there, they will often be copied to a hard disk or a similar intermediate storage medium. When the programs are to be run, they will be loaded either from their distribution medium or their intermediate storage medium into the execution memory of the wireless terminal, configuring an onboard digital computer system (e.g. a microprocessor) to act in accordance with the method of this invention. All these operations are well known to those skilled in the art of computer systems.

The term “computer-readable medium” encompasses distribution media, intermediate storage media, execution memory of a computer, and any other medium or device capable of storing for later reading by a digital computer system a computer program implementing the method of this invention.

Various digital computer system configurations can be employed to perform the method embodiments of this invention, and to the extent that a particular system configuration is capable of performing the method embodiments of this invention, it is equivalent to the representative system embodiments of the invention disclosed herein, and within the scope and spirit of this invention.

Once digital computer systems are programmed to perform particular functions pursuant to instructions from program software that implements the method embodiments of this invention, such digital computer systems in effect become special-purpose computers particular to the method embodiments of this invention. The techniques necessary for this programming are well known to those skilled in the art of computer systems.

FIG. 3 is a block diagram of the exemplary CSPE 100 of FIG. 2 configurable with receiver 304 in one embodiment of the invention. In this embodiment, receiver 304 receives a radio frequency (“RF”) signal through antenna 301 and subsequently converts that signal to a digital received signal (e.g., baseband signal) y using Analog-to-Digital (“A/D”) converter 302. A/D converter 302 transfers the digital signal to receiver circuitry 303 for signal processing. In one embodiment, the received signal y comprises a plurality of CDMA signals. Those skilled in the art should readily recognize that the processing of CDMA signals include both In-phase (“I”) and Quadrature (“Q”) components.

In this embodiment, receiver circuitry 303 is configured for transferring the digitized received signal y to CSPE 100 for cancellation of components of interfering signal paths. CSPE 100 receives the signal y as well as codes corresponding to the interfering signals. For example, the interfering signal paths may be cross channel and/or co-channel interferers comprising known codes of CDMA telephony systems (e.g. spreading codes). Such codes may be input to CSPE 100 on an as needed basis or stored within memory (not shown) local to CSPE 100. Alternatively, the codes may be generated by matrix generator 202 of FIG. 2 on an as needed basis.

Operable characteristics of CSPE 100 are the same as those described in FIG. 2. For example, CSPE 100 uses applicators 206_{1 . . . M} of FIG. 2 to apply cancellation operators to the input signals to substantially cancel interfering signal paths from an input signal. In one embodiment, the applicators 206_{1 . . . M}, using the same signal notation of “A” as described above, produce output canceled signals as follows:
Applicator 206₁ produces an Output Canceled Signal₁ that corresponds to y_{A1}′=P_{A1}^{⊥}y, where again y_{A1}′ is the received signal y with A₁ substantially removed;
Applicator 206₂ produces an Output Canceled Signal₂ corresponding to y_{A1A2}′=P_{A2}^{⊥}y_{A1}′, where again y_{A1A2}′ is Output Canceled Signal₁ with A₂ substantially removed; and
Applicator 206_{M} produces an Output Canceled Signal_{M} corresponding to y_{A1A2AN}′=P_{AN}^{⊥}y_{A1A2}′, where again y_{A1A2AN}′ is Output Canceled Signal₂ with A_{N} substantially removed.

These Output Canceled Signals_{1 . . . R} are transferred to connection element 306 via “X” channel connection 305. X channel connection 305 may be a communicative connection such as a data bus that allows for the transfer of “X” number of channels to connection element 306. The number of channels that are transferred via connection 305 may be greater than or equal to the number of output canceled signals generated by CSPE 100 to accommodate any uncanceled signals. Connection element 306 may, therefore, be configurable to receive such an “X” channel connection.

Connection element 306 is configured for selectively transferring signals (e.g., Output Canceled Signals_{1 . . . R}) to receiver circuitry 303 of receiver 304 via “T” channel connection 307. For example, connection element 306 may be a switching device, multiplexer, a plurality of multiplexers or another similar communication device that selectively transfers “X” number of signals to “T” number of channels. The X number of signals may correspond to R output canceled signals and some number of uncanceled signals. Similar to X, “T” channel connection 307 may be a communicative connection such as a data bus that allows for the transfer of “T” number of channels from connection element 306. In one preferred embodiment, the connection element 306 is communicatively coupled with T processing fingers in the receiver.

The control for connection element 306 may be applied independently of cancellation processing. Consequently, connection element 306 may either be configured within CSPE 100 or external to the CSPE. For example, should selected reception of Output Canceled Signals_{1 . . . R} be decided by receiver 304, then connection element 306 may reside outside of the embodied CSPE 100. In a preferred embodiment, CSPE 100 includes the control functionality for connection element 306 that determines which of the Output Canceled Signals_{1 . . . R} are transferred to receiver circuitry 303. Although, the invention should not be limited to the preferred embodiment described and shown herein.

FIG. 4 is a block diagram of CSPE 100 and receiver 304 illustrating receiver circuitry 303 in one exemplary embodiment of the invention.

In this embodiment, receiver circuitry 303 is configured with CSPE 100 via connection element 306 for selectively demodulating signals through the demodulator of fingers f1, f2 and f3. For example, connection element 306 may allow the receiver circuitry 303 to demodulate a selected combination of Output Canceled Signals_{1 . . . R} and/or the received signal y through the demodulators 403 (labeled 403_{f1 . . . f3}) of processing fingers f1, f2 and f3.

In an exemplary embodiment, a first processing finger f1 receives a signal y. A tracking element 401_{f1} of finger f1 produces a phase estimate φ_{f1} and the on-time PN code x_{f1} of an assigned signal. The phase estimate φ_{f1} and the on-time PN code x_{f1} of the first processing finger f1 are transferred from the finger to CSPE 100 for producing the output canceled signal y_{A1}′ described in FIGS. 2 and 3. Alternatively, the estimation of phase may be performed in CSPE 100.

The tracking element 401_{f1} transfers the signal y and the on-time PN code x_{f1} with the phase estimate φ_{f1} to delay element 410₁. The delay element 410₁ may be implemented by a buffer or some other well known device to compensate for any delays introduced by the signal processing of CSPE 100. Typically, such delays are on the order of one or more symbols. The delay element 410₁ transfers the on-time PN code x_{f1} with the phase estimate φ_{f1} to demodulator 403_{f1}. Delay element 410₁ transfers an undelayed signal y to the selector 402_{f1}. Accordingly, demodulator 403_{f1}, using the undelayed on-time PN code x_{f1}, demodulates the undelayed received signal y via selector 402_{f1}. The output canceled signal y_{A1}′ from CSPE 100 may be selected by selector 402 for any processing finger except for processing finger_{f1}. Such demodulation provides demodulated data_{f1}.

A second processing finger f2 similarly tracks and demodulates a second assigned signal. For example, the assigned signal is tracked in 401_{f2} producing an on-time PN code x_{f2} and possibly a phase estimate φ_{f2} of the assigned signal. The phase estimate φ_{f2} and the on-time PN Code x_{f2} may also be transferred to CSPE 100 to generate output canceled signal y_{A1A2}′, wherein again the signal y_{A1A2}′ has A₂ substantially removed because of the successive cancellation performed on y_{A1}′. The demodulator 403_{f2} selectively receives either the delayed received signal y or Output Canceled Signal y_{A1}′ via a corresponding selector 402_{f2} for the demodulation of the assigned signal using the delayed on-time PN code x_{f2}. The output canceled signal y_{A1A2} may be selected by selector 402 for any processing finger except for processing finger f1 and processing finger f2. This demodulation may provide interference canceled demodulated data_{f2}. Additionally, the received signal y for this processing finger may be delayed via delay element 410₂ by the amount of delay corresponding to the cancellation processing of CSPE 100.

The third processing finger may operate similarly by demodulating either the delayed received signal y or an output canceled signal that has a plurality of interfering signals canceled (e.g., Output Canceled Signal₂ with A₁ and A₂ successively removed). The third processing finger may, therefore, receive a substantially interference canceled signal without the interfering effects of A₁ and A₂. The delay of delay element 410₃ may correspond to two times the delay introduced by delay element 401₂ to compensate for the delay of two successive cancellations by CSPE 100.

In another exemplary embodiment, the delay element 410 may be a fixed delay for all fingers corresponding to a maximum delay, wherein the maximum delay corresponds to a maximum number of successive cancellations.

While one embodiment has been shown and described herein, the embodiment should not be limited to the number of processing fingers shown and described. Nor should the embodiment be limited to the number of cancellations referenced. More processing fingers than those of this exemplary embodiment may be used to selectively track and demodulate signals according to the principles described and illustrated herein. Again, phase estimation is described and shown in further detail in the '346 application.

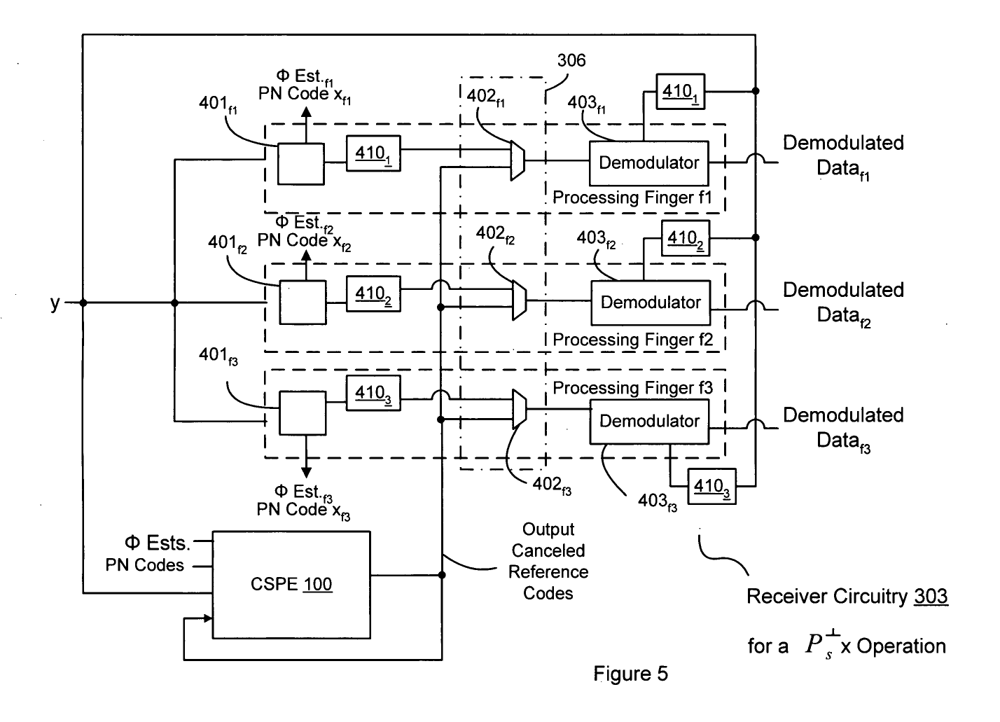

FIG. 5 is another block diagram of CSPE 100 and receiver 304 illustrating another receiver circuitry 303 in one exemplary embodiment of the invention. In this alternative embodiment, receiver circuitry 303 is configured for demodulating signals using output canceled reference codes. As shown, a signal y is transferred to processing fingers f1, f2 and f3 and CSPE 100. Time tracking and phase estimation of the signal y may be performed for each finger in corresponding elements 401_{f1 . . . f3}. Such tracking and phase estimation may be again used to generate corresponding on-time reference PN codes x_{f1 . . . f3} and the phase estimates φ_{f1 . . . f3}.

Elements 401_{f1 . . . f3} transfer the on-time reference PN codes x_{f1 . . . f3} and possibly the phase estimates φ_{f1 . . . f3} to CSPE 100 for use in generating output canceled reference codes. For example, CSPE 100 uses these on-time reference PN codes x_{f1 . . . f3} and phase estimates φ_{f1 . . . f3} to generate cancellation operators that remove interfering signals from reference codes x. The cancellation operators are applied to the on-time reference PN codes x_{f1 . . . f3} to generate output canceled versions of the PN codes.

The PN codes and phase estimates may also be transferred to corresponding delay elements 410 (labeled 410_{1 . . . 3}) to delay the codes and phase estimates to compensate for any delay introduced by CSPE 100. Delay elements 410 of a receiver finger may transfer the delayed reference PN code and phase estimate to a corresponding selector 402 of connection element 306. Again, delay elements 410 may be implemented by a buffer or some other well known device to compensate for introduced delays. The delayed reference PN codes and phase estimates may then be used by a corresponding demodulator to demodulate a signal from the received signal y.

For example, CSPE 100 in this embodiment uses applicators 206 of FIG. 2 to apply cancellation operators to the on-time reference PN codes thereby producing output canceled versions of the codes (e.g., output canceled PN reference codes x_{A1}′, . . . ,x_{AN}′). Such an embodiment may result in a cancellation of the form Pₛ^{⊥}x. These output canceled PN reference codes are selectively transferred to demodulators 403_{f1 . . . f3} via selectors 402_{f1 . . . f3} of connection element 306. These codes may be used by the demodulators 403_{f1 . . . f3} to demodulate the signal y delayed by delay elements 410. The delay of delay elements 410 may again be used to compensate for any delays introduced by CSPE 100. The delay of delay element 410 may be a fixed delay for all fingers corresponding to a maximum delay, wherein the maximum delay corresponds to a maximum number of successive cancellations. Alternatively the delay may be staggered on a finger by finger basis to account for individual delays in CSPE 100. The demodulation in demodulators 403_{f1 . . . f3} may be performed with a correlation of a reference code and the received signal y over a period of a symbol. Such demodulation is well known to those skilled in the art.

In a preferred embodiment, tracking element 401_{f1} of processing finger f1 produces the on-time reference code x_{f1} and the phase estimate φ_{f1}. The reference code x_{f1} and phase estimate φ_{f1} are delayed by delay element 410₁ and transferred to the demodulator 403_{f1} via the selector 402_{f1} of connection element 306. The first finger f1 then demodulates the signal y as delayed by delay element 410₁ using the code x_{f1} and phase estimate φ_{f1}. CSPE 100 may use reference code x_{f1} and/or phase estimate φ_{f1} to generate a set of Output Canceled Reference Codes {x_{A1}′}, wherein the set {x_{A1}′} comprises, for example, output canceled on-time reference PN codes with the interfering effects of A1 substantially removed. The delay of element 410₁ delays the received signal y to demodulator 403_{f1} to compensate for the cancellation processing by CSPE 100.

A demodulator 403_{f2} of processing finger f2 selectively receives either x_{f2} or Output Canceled Reference Code x_{A1}′ corresponding to finger f2 via selector 402_{f2} for demodulation. Similarly, CSPE 100 may use reference code x_{f2} and/or phase estimate φ_{f2} (e.g., provided by tracking element 401_{f2}) to generate a set of Output Canceled Reference Codes {x_{A1A2}′}, wherein the set {x_{A1A2}′} comprises, for example, output canceled on-time reference PN codes with the interfering effects of A₁ and A₂ substantially removed (i.e., because A₁ was substantially removed in the previous cancellation).

A demodulator 403_{f3} of processing finger f3 selectively receives either x_{f3} or Output Canceled Reference Codes {x_{A1}40 } and {x_{A1A2}′} corresponding to finger f3 via selector 402_{f3} for demodulation. For example, CSPE 100 may use reference code x_{f3} and/or phase estimate φ_{f3} (e.g., provided by tracking element 401_{f3}) to generate a set of Output Canceled Reference Codes {x_{A1A2A3}′}, wherein the set {x_{A1A2A3}′} comprises, for example, the output canceled on-time reference PN codes with the interfering effects of A₁, A₂ and A₃ substantially removed (i.e., because A₁ and A₂ were substantially removed in the previous two cancellations).

While one exemplary preferred embodiment has been shown and described herein, the embodiment should not be limited to the number of processing fingers of the preferred embodiment. Nor should the embodiment be limited to the number of cancellations referenced. More processing fingers than those of this exemplary embodiment may be used to selectively track and demodulate signals according to the principles described and illustrated herein. Additionally, any processing finger shown and described herein may provide an on-time reference PN code associated with an interfering signal path to CSPE 100. In other embodiments, however, the on-time reference PN code is generated from within CSPE 100.

FIG. 6 is another block diagram of CSPE 100 and the receiver illustrating receiver circuitry 303 in one exemplary embodiment of the invention. In this alternative embodiment, receiver circuitry 303 is configured for demodulating signals using output canceled received signals. As shown, a signal y is transferred to CSPE 100. Time tracking and phase estimation of signals tracked by processing fingers f1, f2 and f3 may be input to CSPE 100 as well. CSPE 100 outputs interference canceled received signals and/or an uncanceled received signal (i.e., the signal y without cancellation performed thereon). Moreover, interference canceled received signals can be input to the CSPE 100 as well.

The canceled and uncanceled signals are time-aligned at the output of CSPE 100 through the implementation of delay element 407 that delays the uncanceled signals by a duration introduced by the processing of canceled signals by CSPE 100. The canceled and uncanceled signals are transferred to selectors 402 of connection element 306 for selected transfer to processing fingers f1, f2 and/or f3. The canceled signals are also transferred to CSPE 100 for successive cancellation phase estimates from tracking element 401 and on-time PN codes. Each tracking element 401 tracks the signal path assigned to a processing finger and produces a phase estimate and on-time PN code for the signal path.

For each processing finger, the on-time PN code and the phase estimate of the signal path are transferred back to CSPE 100 for use in interference selection. Since the on-time PN code is delayed in alignment relative to the received signal y input to CSPE 100 (i.e., because of the delay introduced by CSPE 100), the on-time PN code is advanced in advance element 405 by a duration substantially equal to the delay introduced by CSPE 100 processing, which is equivalent to the delay introduced by delay element 407. Since PN code tracking and phase estimation is performed on a delayed signal input to a processor, the phase and on-time PN code is estimated by a duration equivalent to the delay introduced by CSPE 100. However, a stationary phase estimate may be made in which the phase is assumed to be constant for the duration of processing multiple symbols by CSPE 100. In one embodiment, a two-symbol delay for one signal cancellation in the CSPE 100 results in advance element 405 advancing the on-time PN code by two symbols. If a signal has undergone two successive interference cancellation operations then advance element 405 may advance the on-time PN code by four symbols. In a second embodiment, the advance element 405 may advance all on-time PN code by a fixed delay that is equivalent to the duration of the CSPE 100 doing the maximum number of successive cancellations. The advanced on-time PN code is then input to CSPE 100 to selectively perform cancellation.

FIG. 7 is a block diagram of CSPE 100 and the receiver illustrating another receiver circuitry 303 in one exemplary embodiment of the invention. In this alternative embodiment, receiver circuitry 303 is configured for tracking and demodulating signals using output canceled reference codes. The received signal y is transferred to CSPE 100 and, via delay block 407, to the processing fingers. The delay of delay block 407 is substantially equivalent to the processing delay introduced by CSPE 100. The delay of delay block 407 may be substantially equivalent to the individual delay introduced by CSPE 100 on each individual substantially interference canceled signal or it may be substantially equivalent to the maximum delay that CSPE 100 may introduce by the maximum number of successive cancellations. The received signal y may be transferred to the processing fingers f1 . . . f3 via CSPE 100. CSPE 100 receives or calculates on-time PN codes and phase estimates of the signals that may be selected for cancellation. If the phase estimates and on-time PN codes are transferred from tracking element 401 the on-time PN code is advanced by an amount substantially equivalent to the delay introduced by CSPE 100, which is also substantially equal to the delay introduced by delay element 407. CSPE 100 applies a cancellation operator to selected reference codes, which are subsequently output to the processing fingers via selectors 402 of connection element 306. The interference reference codes output from CSPE 100 may be input to CSPE 100 for successive cancellation.

In one exemplary embodiment, three canceled reference codes may be required for each processing finger processing an output canceled reference code. The canceled reference codes may be produced by an application of a single cancellation operator to a reference PN code or an interference canceled reference PN code. The canceled reference codes may consist of early, late and prompt PN codes where the prompt PN refers to the on-time PN code and the early and late PN codes are advanced and delayed versions of the prompt PN code, respectively. These PN codes for a given finger may be transferred via selector 402 to the processing finger. Tracking element 401 may utilize the early and late PN codes for tracking of the canceled signal. The prompt PN code may be used for phase estimation in the corresponding tracking element 401 and for demodulation in the corresponding demodulator 403 (labeled 403_{f1 . . . f3}). Early, late and prompt PN codes are well known to those skilled in the art.

In another exemplary embodiment, the processing finger may receive a longer interference canceled PN code sequence that comprises three overlapping interference canceled reference codes (i.e., early, late and prompt). For example, if the PN codes are L samples in length and the offset between the prompt PN code and the early and late PN codes is 4 samples then the longer interference canceled PN code sequence is L+8 samples in length. The early PN code sequence comprises samples 1 through L, the prompt PN code comprises samples 5 through L+4 and the late PN code comprises samples 9 through L+8 of the longer interference canceled PN code sequence. The early, prompt and late reference codes are then used by tracking element 401 for tracking and demodulator 403 for the demodulation of the selected signal as is known to those skilled in the art.

Tracking element 401 performs tracking on the assigned signal utilizing either uncanceled generated PN codes or output canceled PN codes. A phase estimate and on-time reference code is output from the tracking element 401. The on-time reference code is advanced via advance element 405 by an amount substantially equivalent to the delay of the CSPE 100, which is substantially equivalent to delay element 407. This advanced on-time reference code and phase estimate are then input to CSPE 100 to perform interference cancellation.

FIG. 8 is a flow chart 500 illustrating one exemplary methodical embodiment of the invention. In this embodiment, a signal is received and interfering channels of a signal path of the received signal are selected, in element 501. A first interfering signal path is used to generate a cancellation operator, in element 502. The cancellation operator may be a projection operator as described in FIG. 2 that is generated in element 503 to project a received signal and/or a reference signal onto a subspace that is substantially orthogonal to the interfering signal path. The cancellation operator is used to substantially cancel an interfering signal from an input signal, in element 504. For example, the cancellation operator may be applied to either the received signal y or an on-time PN reference code.

The use of the cancellation operator in element 504 produces an output canceled signal such as described herein. Once an output canceled signal is produced, the signals may be selected for a particular finger and transferred to a receiver, in element 510. Additionally, the output canceled signal may be fed back for a successive cancellation based on a determination in element 505. For example, if a determination is made to cancel additional signals, the output canceled signal is transferred to an input of a CSPE for a successive cancellation thereon, in element 506. If signal cancellation is no longer required, the output canceled signal that was transferred to the receiver in element 510 may continue to be processed by the receiver, in element 511.

Once the output canceled signal is received by the CSPE, another cancellation operator is generated therefrom, in element 507. The cancellation operator is then applied to the output canceled signal to substantially cancel a second set of one or more interfering signals from the output canceled signal, in element 508. For example, a first cancellation performed in element 504 may remove a first set of interfering signals and generate an output canceled signal with the effects of the first interfering signals removed. Accordingly, the second cancellation performed in element 508 may remove a second set of interfering signals from the output canceled signal to generate a second output canceled signal without the interfering effects of the first and second interfering signals. This second output canceled signal may be also selected for a particular finger and transferred to a receiver, in element 510.

A determination may again be made whether to cancel other signals, in element 512. As such, if a decision is made to cancel additional signals, the second output canceled signal is transferred to an input of a CSPE for a successive cancellation(s) thereon. If signal cancellation is no longer required, the output canceled signal that was transferred to the receiver in element 510 may again continue to be processed by the receiver, in element 513.

While discussed in detail with respect to serial cancellation being performed with successive applications of cancellation operators, those skilled in the art should readily recognize that other combinations of cancellations may be performed. For example, after canceling one or more interfering signals from a first input signal, the CSPE may selectively and successively cancel one or more interfering signals from an output canceled signal. Accordingly, the invention is not intended to be limited to the preferred embodiment shown and described herein. Rather, the invention is only intended to be limited by the language recited in the claims and their equivalents.

The embodiments described herein may substantially reduce interference caused by unwanted signals and improve signal processing. For example, poor signal quality due to interference may deleteriously affect acquisition, tracking and/or demodulation of selected signals. A reduction of interference may, therefore, improve recovery of a transmitted signal. In regards to such benefits, the embodiments herein may advantageously require use within a CDMA communication system. Improved processing within a CDMA communication system may be exploited in terms of increased system capacity, transmit power reduction, system coverage and/or data rates. However, those skilled in the art should readily recognize that the above embodiments should not be limited to any particular type of signaling. For example, the embodiments disclosed herein may be advantageous to systems employing CDMA (e.g., such as cdmaOne and cdma2000), WCDMA, Broadband CDMA, UMTS and/or GPS signals.

Additionally, it should be noted that the above embodiments of the invention may be implemented in a variety of ways. For example, the above embodiments may be implemented in software, firmware, hardware or various combinations thereof. Those skilled in the art are familiar with software, firmware, hardware and their various combinations. To illustrate, those skilled in the art may choose to implement certain aspects of the invention in hardware using ASIC chips, DSPs, FPGAs and/or other circuitry. Still, some aspects of the invention may be implemented through combinations of software using C, C++, Matlab, VHDL, Verilog and/or processor specific machine and assembly languages. Accordingly, those skilled in the art should readily recognize that such implementations are a matter of design choice and that the invention should not be limited to any particular implementation.

While the invention has been illustrated and described in detail in the drawings and foregoing description, such illustration and description is to be considered as exemplary and not restrictive in character. Accordingly, it should be understood that only the preferred embodiment and minor variants thereof have been shown and described and that all changes and modifications that come within the spirit of the invention are desired to be protected.

1. A processing engine, comprising:
a first input configured for receiving an input signal;
a plurality of outputs, wherein each output is configured for providing a substantially interference canceled signal;
at least one second input configured for receiving one of the substantially interference canceled signals from one of the outputs,
wherein the processing engine is configured for substantially canceling an interfering signal from the input signal and from at least one of the substantially interference canceled signals.

2. The processing engine of claim 1, wherein the processing engine is configurable with at least one of a handset receiver and a base station receiver.

3. The processing engine of claim 1, further comprising an interference selector configured for receiving the input signal and the substantially interference canceled signal and for selecting an interfering signal from each of the input signal and said at least one substantially interference canceled signal.

4. The processing engine of claim 3, further comprising a plurality of matrix generators, wherein each of the plurality of matrix generators is communicatively coupled to the interference selector and configured for generating a matrix based on a selected interfering signal provided by the interference selector.

5. The processing engine of claim 4, wherein each of the plurality of matrix generators is configured to generate a matrix constructed from at least one vector to produce a plurality of matrices, and wherein each of the at least one vector comprises elements from the selected interfering signal.

6. The processing engine of claim 4, wherein the processing engine is further configured for substantially canceling a plurality of interfering signals from the input signal or from at least one of the substantially interference canceled signals wherein each matrix generator is configured for generating a matrix based on a selected plurality of interfering signals.

7. The processing engine of claim 6, wherein the plurality of matrix generators are adapted to construct the plurality of matrices from at least one vector, and wherein at least one of the at least one vector is a composite vector comprising elements from at least two of the selected plurality of interfering signals.

8. The processing engine of claim 1, further comprising a processor configured for generating a plurality of cancellation operators, wherein each cancellation operator is used to substantially cancel one of the interfering signals to produce at least one substantially interference canceled signal.

9. The processing engine of claim 8, further comprising a plurality of applicators, wherein each applicator is communicatively coupled to the processor and configured for applying one of the cancellation operators to either the input signal or said at least one substantially interference canceled signal.

10. The processing engine of claim 9, wherein at least one of the applicators is configured for applying one of the cancellation operators according to the form:
y=y−S(S^{T}S)⁻¹S^{T} y,
where y′ is an output canceled signal, y is a received signal, S is an interference matrix and S^{T} is a transpose of S.

11. The processing engine of claim 8, wherein each cancellation operator is a projection operator configured for projecting either the input signal or said at least one substantially interference canceled signal onto a subspace that is substantially orthogonal to one of the interfering signals.

12. The processing engine of claim 11, wherein each projection operator comprises the form:
Pₛ^{⊥}=I−S(S^{T}S)⁻¹S^{T},
wherein Pₛ^{⊥} is the projection operator, I is an identity matrix, S is an interference matrix and S^{T} is a transpose of the interference matrix.

13. The processing engine of claim 8, wherein at least one of the cancellation operators is configured to substantially cancel one of the interfering signals via an approximated projection operation comprising the form:
$${y}^{′} \approx y - {\sum }_{j = 1}^{t} \frac{〈 {s}_{j} , y 〉}{{‖ {s}_{j} ‖}^{2}} {s}_{j}$$
where y′ is an output canceled signal, y is a received signal, S is an interference matrix, Sⱼ is the j^{th} column vector of S and t is the number of vectors in S.

14. The processing engine of claim 1, wherein the input signal comprises a plurality of digital signals selected from a group consisting of a Code Division Multiple Access signal, a Wideband Code Division Multiple Access signal, a broadband Code Division Multiple Access signal, a Global Positioning Signal, and a Universal Mobile Telephone Service signal.

15. The processing engine of claim 1, further comprising at least one delay element, wherein each of the at least one delay element is used for compensating delay introduced by the processing engine.

16. The processing engine of claim 1, further comprising at least one advance element, wherein each of the at least one advance element is adapted to advance an on-time PN code by a duration substantially equal to delay introduced by the processing engine.

17. A method, comprising:
providing for receiving an input signal;
providing for substantially canceling a signal interfering with the input signal to generate a first substantially interference canceled signal;
providing for receiving the first substantially interference canceled signal; and
providing for substantially canceling a signal interfering with the first substantially interference canceled signal to generate a second substantially interference canceled signal.

18. The method of claim 17, further comprising providing for generating a cancellation operator in response to receiving the input signal.

19. The method of claim 18, wherein providing for generating the cancellation operator comprises providing for generating a projection operator according to the form:
Pₛ^{⊥}=I−S(S^{T}S)⁻¹S^{T},
wherein Pₛ^{⊥} is the projection operator, I is an identity matrix, S is an interference matrix and S^{T} is a transpose of the interference matrix.

20. The method of claim 17, wherein providing for substantially canceling the signal interfering with the input signal comprises providing for performing a cancellation operation on the input signal according to the form:
y′=y−S(S^{T}S)⁻¹S^{T} y,
where y′ is the first substantially interference canceled signal, y is a received signal, S is an interference matrix and S^{T} is a transpose of S.

21. The method of claim 17, wherein providing for substantially canceling the signal interfering with the input signal comprises providing for performing a cancellation operation on the input signal resulting in an approximated projection comprising the form:
$${y}^{′} \approx y - {\sum }_{j = 1}^{t} \frac{〈 {s}_{j} , y 〉}{{‖ {s}_{j} ‖}^{2}} {s}_{j}$$
where y′ is an output canceled signal, y is a received signal, S is an interference matrix, sⱼ is the j^{th} column vector of S and t is the number of vectors in S.

22. The method of claim 17, further comprising providing for generating a cancellation operator in response to receiving the first substantially interference canceled signal.

23. The method of claim 22, wherein providing for generating the cancellation operator comprises providing for generating a projection operator according to the form:
Pₓ^{⊥}=I−S(S^{T}S)⁻¹S^{T},
wherein Pₛ^{⊥} is the projection operator, I is an identity matrix, S is an interference matrix and S^{T} is a transpose of the interference matrix.

24. The method of claim 17, wherein providing for substantially canceling the signal interfering with the first substantially interference canceled signal comprises providing for performing a cancellation operation on the first substantially interference canceled signal according to the form:
y″=y′−S(S^{T}S)⁻¹S^{T} y,
where y″ is the second substantially interference canceled signal, y′ is the first substantially interference canceled signal, S is an interference matrix and S^{T} is a transpose of S.

25. The method of claim 17, wherein providing for substantially canceling the signal interfering with the first substantially interference canceled signal comprises providing for performing a cancellation operation on the first substantially interference canceled signal resulting in an approximated projection operation comprising the form:
$${y}^{″} \approx {y}^{′} - {\sum }_{j = 1}^{t} \frac{〈 {s}_{j} , y 〉}{{‖ {s}_{j} ‖}^{2}} {s}_{j}$$
where y″ is the second substantially interference canceled signal, y′ is the first substantially interference canceled signal, S is an interference matrix, sⱼ is the j^{th} column vector of S and t is the number of vectors in S.

26. The method of claim 17, further comprising providing for transferring the first substantially interference canceled signal and the second substantially interference canceled signal to a receiver.

27. The method of claim 26, wherein the receiver is configurable with a handset or a base station.

28. The method of claim 17, wherein the input signal comprises a plurality of digital signals selected from a group consisting of a Code Division Multiple Access signal, a Wideband Code Division Multiple Access signal, a broadband Code Division Multiple Access signal, a Global Positioning Signal and a Universal Mobile Telephone Service signal.

29. The method of claim 17, further comprising providing for delaying the input to compensate for delay introduced by the processing engine.

30. The method of claim 17, further comprising providing for advancing an on-time PN code by a duration substantially equal to delay introduced by the processing engine.

31. A system, comprising:
an input signal coupler configured for receiving an input signal;
an interference canceller configured for substantially canceling a signal interfering with the input signal to generate a first substantially interference canceled signal;
an interference canceled signal coupler configured for receiving the first substantially interference canceled signal, wherein the interference canceller is further configured for substantially canceling a signal interfering with the first substantially interference canceled signal to generate a second substantially interference canceled signal.

32. The system of claim 31, further comprising means for generating a cancellation operator in response to receiving the input signal.

33. The system of claim 32, wherein the means for generating the cancellation operator comprises means for generating a projection operator according to the form:
Pₛ^{⊥}=I−S(S^{T}S)⁻¹S^{T},
wherein Pₛ^{⊥} is the projection operator, I is an identity matrix, S is an interference matrix and S^{T} is a transpose of the interference matrix.

34. The system of claim 31, wherein the means for substantially canceling the signal interfering with the input signal comprises means for performing a cancellation operation on the input signal according to the form:
y′=y−S(S^{T}S)⁻¹S^{T} y,
where y′ is the first substantially interference canceled signal, y is a received signal, S is an interference matrix and S^{T} is a transpose of S.

35. The system of claim 31, wherein the means for substantially canceling the signal interfering with the input signal comprises means for performing a cancellation operation on the input signal resulting in an approximated projection comprising the form:
$${y}^{′} \approx y - {\sum }_{j = 1}^{t} \frac{〈 {s}_{j} , y 〉}{{‖ {s}_{j} ‖}^{2}} {s}_{j}$$
where y′ is an output canceled signal, y is a received signal, S is an interference matrix, sⱼ is the j^{th} column vector of S and t is the number of vectors in S.

36. The system of claim 31, further comprising means for generating a cancellation operator in response to receiving the first substantially interference canceled signal.

37. The system of claim 36, wherein the means for generating the cancellation operator comprises means for generating a projection operator according to the form:
Pₛ^{⊥}=I−S(S^{T}S)⁻¹S^{T},
wherein Pₛ^{⊥} is the projection operator, I is an identity matrix, S is an interference matrix and S^{T} is a transpose of the interference matrix.

38. The system of claim 31, wherein the means for substantially canceling the signal interfering with the first substantially interference canceled signal comprises means for applying a cancellation operator to the input signal according to the form:
y″=y′−S(S^{T}S)⁻¹S^{T} y,
where y′ is the second substantially interference canceled signal, y′ is the first substantially interference canceled signal, S is an interference matrix and S^{T} is a transpose of S.

39. The system of claim 31, wherein the means for substantially canceling the signal interfering with the first substantially interference canceled signal comprises means for performing a cancellation operation on the first substantially interference canceled signal according to the form:
y″=y′−S(S^{T}S)⁻¹S^{T} y,
where y″ is the second substantially interference canceled signal, y′ is the first substantially interference canceled signal, S is an interference matrix and S^{T} is a transpose of S.

40. The system of claim 31, wherein the means for substantially canceling the signal interfering with the first substantially interference canceled signal comprises means for performing a cancellation operation on the first substantially interference canceled signal resulting in an approximated projection operation comprising the form:
$${y}^{″} \approx {y}^{′} - {\sum }_{j = 1}^{t} \frac{〈 {s}_{j} , y 〉}{{‖ {s}_{j} ‖}^{2}} {s}_{j}$$
where y″ is the second substantially interference canceled signal, y′ is the first substantially interference canceled signal, S is an interference matrix, sⱼ is the j^{th} column vector of S and t is the number of vectors in S.

41. The system of claim 31, further comprising means for transferring the first substantially interference canceled signal and the second substantially interference canceled signal to a receiver.

42. The system of claim 41, wherein the receiver is configurable with a handset or a base station.

43. The system of claim 31, wherein the input signal comprises a plurality of digital signals selected from a group consisting of a Code Division Multiple Access signal, a Wideband Code Division Multiple Access signal, a broadband Code Division Multiple Access signal, a Global Positioning Signal, and a Universal Mobile Telephone Service signal.

44. The system of claim 31, further comprising one or more delay elements, wherein each of the one or more delay elements is configured for compensating delay introduced by the processing engine.

45. The system of claim 31, further comprising one or more advance elements, wherein each of the one or more advance elements is configured for advancing an on-time PN code by a duration substantially equal to delay introduced by the processing engine.

46. A method, comprising:
providing for receiving an input signal in an Coded Signal Processing Engine;
providing for selecting a first set of one or more interfering signals from the input signal to generate a selected first set of one or more interfering signals;
providing for generating a cancellation operator from the selected first set of one or more interfering signals;
providing for using the cancellation operator to substantially cancel the selected first set of one or more interfering signals and to generate a first substantially interference canceled signal;
providing for transferring the first substantially interference canceled signal to the Coded Signal Processing Engine; and
providing for selecting a second set of one or more interfering signals from the first substantially interference canceled signal to generate a selected second set of one or more interfering signals;
providing for generating a cancellation operator from the selected second set of one or more interfering signals;
providing for using the cancellation operator to substantially cancel the selected second set of one or more interfering signals and to generate a second substantially interference canceled signal;

47. The method of claim 46, wherein providing for generating the cancellation operator comprises providing for generating a projection operator according to the form:
Pₛ^{⊥}=I−S(S^{T}S)⁻¹S^{T},
wherein Pₛ^{⊥} is the projection operator, I is an identity matrix, S is an interference matrix and S^{T} is a transpose of the interference matrix.

48. The method of claim 46, wherein providing for using the cancellation operator to substantially cancel either the selected said first set of one or more interfering signals or the selected said second set of one or more interfering signals comprises providing for applying a cancellation operator according to the form:
y′=y−S(S^{T}S)⁻¹S^{T} y,
where y is either an uncanceled signal or an interference canceled signal, y′ is a new interference canceled signal, S is an interference matrix and S^{T} is a transpose of S.

49. The method of claim 46, wherein providing for using the cancellation operator to substantially cancel either the selected first set of one or more interfering signals or the selected second set of one or more interfering signals comprises means for performing a cancellation resulting in an approximated projection operation according the form:
$${y}^{′} \approx y - {\sum }_{j = 1}^{t} \frac{〈 {s}_{j} , y 〉}{{‖ {s}_{j} ‖}^{2}} {s}_{j}$$
where y is either an uncanceled signal or an interference canceled signal, y′ is a new interference canceled signal, S is an interference matrix, sⱼ is the j^{th} column vector of S and t is the number of vectors in S.

50. A digital computer system programmed to perform the method of claim 17, 18, 19, 20, 21, 22, 23, 24, 25, 26, 27, 28, 29, 30, 46, 47, 48, or 49.

51. A computer-readable medium storing a computer program implementing the method of claim 17, 18, 19, 20, 21, 22, 23, 24, 25, 26, 27, 28, 29, 30, 46, 47, 48, or 49.

52. A handset comprising a processing engine, the processing engine comprising:
a first input configured for receiving an input signal;
a plurality of outputs, wherein each output is configured for providing a substantially interference canceled signal;
at least one second input configured for receiving one of the substantially interference canceled signals from one of the outputs,
wherein the processing engine is configured for substantially canceling an interfering signal from the input signal and from at least one of the substantially interference canceled signals.

53. The handset recited in claim 52, further comprising an interference selector configured for receiving the input signal and the substantially interference canceled signal and for selecting an interfering signal from each of the input signal and said at least one substantially interference canceled signal.

54. The handset of claim 53, further comprising a plurality of matrix generators, wherein each of the plurality of matrix generators is communicatively coupled to the interference selector and configured for generating a matrix based on a selected interfering signal provided by the interference selector.

55. The handset of claim 54, wherein each of the plurality of matrix generators is configured to generate a matrix constructed from at least one vector to produce a plurality of matrices, and wherein each of the at least one vector comprises elements from the selected interfering signal.

56. The handset of claim 54, wherein the processing engine is further configured for substantially canceling a plurality of interfering signals from the input signal or from at least one of the substantially interference canceled signals wherein each matrix generator is configured for generating a matrix based on a selected plurality of interfering signals.

57. The handset of claim 56, wherein the plurality of matrix generators are adapted to construct the plurality of matrices from at least one vector, and wherein at least one of the at least one vector is a composite vector comprising elements from at least two of the selected plurality of interfering signals.

58. The handset of claim 52, further comprising a processor configured for generating a plurality of cancellation operators, wherein each cancellation operator is used to substantially cancel one of the interfering signals to produce at least one substantially interference canceled signal.

59. The handset of claim 58, further comprising a plurality of applicators, wherein each applicator is communicatively coupled to the processor and configured for applying one of the cancellation operators to either the input signal or said at least one substantially interference canceled signal.

60. The handset of claim 59, wherein at least one of the applicators is configured for applying one of the cancellation operators according to the form:
y′=y−S(S^{T}S)⁻¹S^{T} y,
where y′ is an output canceled signal, y is a received signal, S is an interference matrix and S^{T} is a transpose of S.

61. The handset of claim 58, wherein each cancellation operator is a projection operator configured for projecting either the input signal or said at least one substantially interference canceled signal onto a subspace that is substantially orthogonal to one of the interfering signals.

62. The handset of claim 61, wherein each projection operator comprises the form:
Pₛ^{⊥}=I−S(S^{T}S)⁻¹S^{T},
wherein Pₛ^{⊥} is the projection operator, I is an identity matrix, S is an interference matrix and S^{T} is a transpose of the interference matrix.

63. The handset of claim 58, wherein at least one of the cancellation operators is configured to substantially cancel one of the interfering signals via an approximated projection operation comprising the form:
$${y}^{′} \approx y - {\sum }_{j = 1}^{t} \frac{〈 {s}_{j} , y 〉}{{‖ {s}_{j} ‖}^{2}} {s}_{j}$$
where y′ is an output canceled signal, y is a received signal, S is an interference matrix, sⱼ is the j^{th} column vector of S and t is the number of vectors in S.

64. The handset of claim 52, wherein the input signal comprises a plurality of digital signals selected from a group consisting of a Code Division Multiple Access signal, a Wideband Code Division Multiple Access signal, a broadband Code Division Multiple Access signal, a Global Positioning Signal, and a Universal Mobile Telephone Service signal.

65. The processing engine of claim 52, further comprising at least one delay element, wherein each of the at least one delay element is used for compensating delay introduced by the processing engine.

66. The processing engine of claim 52, further comprising at least one advance element, wherein each of the at least one advance element is adapted to advance an on-time PN code by a duration substantially equal to delay introduced by the processing engine.

67. A handset, comprising:
an antenna configured for receiving a radio signal, wherein the radio signal comprises at least one signal of interest and one or more interfering signals;
an analog to digital converter configured for converting the radio signal to a digital signal;
an input signal coupler configured for receiving the digital signal to produce an input signal;
an interference canceller configured for substantially canceling a signal interfering with the input signal to generate a first substantially interference canceled signal;
an interference canceled signal coupler configured for receiving the first substantially interference canceled signal, wherein the interference canceller is further configured for substantially canceling a signal interfering with the first substantially interference canceled signal to generate a second substantially interference canceled signal.

68. The handset of claim 67, further comprising means for generating a cancellation operator in response to receiving the input signal.

69. The handset of claim 68, wherein the means for generating the cancellation operator comprises means for generating a projection operator according to the form:
Pₛ^{⊥}=I−S(S^{T}S)⁻¹S^{T},
wherein Pₛ^{⊥} is the projection operator, I is an identity matrix, S is an interference matrix and S^{T} is a transpose of the interference matrix.

70. The handset of claim 67, wherein the interference canceller comprises means for performing a cancellation operation on the input signal according to the form:
y′=y−S(S^{T}S)⁻¹S^{T} y,
where y′ is the first substantially interference canceled signal, y is a received signal, S is an interference matrix and S^{T} is a transpose of S.

71. The handset of claim 67, wherein the interference canceller comprises means for performing a cancellation operation on the input signal resulting in an approximated projection comprising the form:
$${y}^{′} \approx y - {\sum }_{j = 1}^{t} \frac{〈 {s}_{j} , y 〉}{{‖ {s}_{j} ‖}^{2}} {s}_{j}$$
where y′ is an output canceled signal, y is a received signal, S is an interference matrix, sⱼ is the j^{th} column vector of S and t is the number of vectors in S.

72. The handset of claim 67, further comprising means for generating a cancellation operator in response to receiving the first substantially interference canceled signal.

73. The handset of claim 72, wherein the means for generating the cancellation operator comprises means for generating a projection operator according to the form:
Pₛ^{⊥}=I−S(S^{T}S)⁻¹S^{T},
wherein Pₛ^{⊥} is the projection operator, I is an identity matrix, S is an interference matrix and S^{T} is a transpose of the interference matrix.

74. The handset of claim 67, wherein the interference canceller comprises means for applying a cancellation operator to the input signal according to the form:
y″=y′−S(S^{T}S)⁻¹S^{T} y,
where y′ is the second substantially interference canceled signal, y′ is the first substantially interference canceled signal, S is an interference matrix and S^{T} is a transpose of S.

75. The handset of claim 67, wherein the interference canceller comprises means for performing a cancellation operation on the first substantially interference canceled signal according to the form:
y″=y′−S(S^{T}S)⁻¹S^{T} y,
where y″ is the second substantially interference canceled signal, y′ is the first substantially interference canceled signal, S is an interference matrix and S^{T} is a transpose of S.

76. The handset of claim 67, wherein the interference canceller comprises means for performing a cancellation operation on the first substantially interference canceled signal resulting in an approximated projection operation comprising the form:
$${y}^{″} \approx {y}^{′} - {\sum }_{j = 1}^{t} \frac{〈 {s}_{j} , y 〉}{{‖ {s}_{j} ‖}^{2}} {s}_{j}$$
where y″ is the second substantially interference canceled signal, y′ is the first substantially interference canceled signal, S is an interference matrix, sⱼ is the j^{th} column vector of S and t is the number of vectors in S.

77. The handset of claim 67, further comprising means for transferring the first substantially interference canceled signal and the second substantially interference canceled signal to a receiver.

78. The handset of claim 77, wherein the receiver is configurable with a handset or a base station.

79. The handset of claim 67, wherein the input signal comprises a plurality of digital signals selected from a group consisting of a Code Division Multiple Access signal, a Wideband Code Division Multiple Access signal, a broadband Code Division Multiple Access signal, a Global Positioning Signal, and a Universal Mobile Telephone Service signal.

80. The system of claim 67, further comprising one or more delay elements, wherein each of the one or more delay elements is configured for compensating delay introduced by the processing engine.

81. The system of claim 67, further comprising one or more advance elements, wherein each of the one or more advance elements is configured for advancing an on-time PN code by a duration substantially equal to delay introduced by the processing engine.
